(19) United States
(12) Patent Application Publication
(10) Pub. No.: US 2008/0122820 A1
(43) Pub. Date: May 29, 2008

(54) Gradation potential generation circuit, data driver of display device and the display device

(75) Inventors: Kengo Umeda, Kanagawa (JP); Hiroshi Tsuchi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/979,799

(22) Filed: Nov. 8, 2007

(30) Foreign Application Priority Data
Nov. 29, 2006 (JP) 2006-321220

(51) Int. Cl. G09G 5/00

(52) U.S. Cl. 345/205

(57) ABSTRACT

A gradation potential generation circuit includes a first ladder resistance circuit supplied with a first and a second reference voltages to both ends to generate j number of gradation potentials (j is an integer of 2 or more) and output the generated j number of gradation potentials to j number of first nodes, where the j number of gradation potentials being generated by dividing the first and the second reference voltages, a second ladder resistance circuit to generate k number of gradation potentials out of the j number of gradation potentials (where j>k) generated by the first ladder resistance circuit and k number of switches to supply the k number of gradation potentials generated by the second ladder resistance circuit to k number of first nodes out of the j number of first nodes according to a first control signal.

### BACKGROUND OF THE INVENTION

1. Field of the Invention

The present invention relates to a gradation potential generation circuit, a data driver of a display device and the display device.

2. Description of Related Art

A liquid crystal display device (LCD) is widely utilized for OA, consumer use and industrial use as an indispensable flat-panel display device in the information and telecommunication age taking advantage of the feature of thin shape, light weight, and low power. Generally, a liquid crystal driving IC (liquid crystal driving circuit) having a gradation potential generation circuit is disposed in such a liquid crystal display device. A plurality of gradation potentials are generated by this gradation potential generation circuit. Then, one of the plurality of the gradation potentials is selected by a decoding circuit according to an image data signal. The current of the gradation potential selected by the decoding circuit is amplified by a voltage follower. The amplified gradation potential is supplied to the liquid crystal panel via a data line.

FIG. 10 is a block diagram showing the structure of a 6-bit data driver IC 3. The data driver IC 3 includes a receiver & serial/parallel conversion circuit 10, a latch circuit 11, a shift register circuit 12, a decoding circuit 13 and a gradation potential generation circuit 14. The receiver & serial/parallel conversion circuit 10 receives a serial image data signal sent from a timing controller IC and converts into parallel data D00 to D05 for every pixel. The shift register circuit 12 sequentially transmits the parallel data D00 to D05 converted by the receiver & serial/parallel conversion circuit 10 and transmits data for 1 line of a gate signal line. This parallel data D00 to D05 is sent to the latch circuit 11 which is a memory circuit and digital gradation data corresponding to the number of outputs is stored. Gradation potentials VDATA0 to VDATA63 are input into the decoding circuit 13. Then, the decoding circuit 13 selects a gradation potential corresponding to the digital gradation data D00 to D05 sent from the latch circuit 11 for every output from the gradation potentials VDATA0 to VDATA63 input. Note that the gradation potentials VDATA0 to VDATA63 are generated by the gradation potential generation circuit 14 and are output to the decoding circuit 13. Moreover, the gradation potentials VDATA0 to VDATA63 are shared between outputs having the same polarity in the decoding circuit 13. Then, the gradation potential for every output selected by the decoding circuit 13 is output to inputs t1 to t720 of a voltage follower 15 provided for every output, when the number of outputs is 720, for example. That is, when the gradation potential is selected by the decoding circuit 13, the inputs of the voltage followers 15 (t1 to t720) of all the outputs are charged and discharged. Then, the selected gradation potential is supplied to each pixel of a liquid crystal panel via data lines (out1 to out720) 16.

When supplying the gradation potentials to the inputs t1 to t720 of the voltage follower 15, it takes time to reach the level of the target gradation potential. The time taken corresponds to a time constant determined by an input capacitance of the voltage follower 15, an output impedance of the gradation potential generation circuit 14, and a resistance component of the decoding circuit 13. If this time is long, the writing of a voltage to the liquid crystal panel will become slow and will affect an image, thus it is necessary to shorten as much as possible.

The gradation potential generation circuit 14 of the liquid crystal display device is disclosed in Japanese Unexamined Patent Application Publication No. 2005-37746, for example. This gradation potential generation circuit 14 is explained with reference to FIGS. 11 and 12. FIG. 11 shows the structure of the gradation potential generation circuit 14. FIG. 12 is a timing chart of the gradation potential generation circuit 14.

As shown in FIG. 11, the gradation potential generation circuit 14 includes a first power supply line VDD, a second power supply line VCOM, a first ladder resistance circuit 20, a second ladder resistance circuit 21 and switches S1 to S64. The first ladder resistance circuit 20 generates a plurality of gradation potentials and supplies the generated gradation potentials to a plurality of first nodes, respectively. Specifically, the first ladder resistance circuit 20 is formed by resistances R1 to R64 which divide the potential difference of the first power supply line VDD and the second power supply line VCOM and generate the gradation potentials VDATA0 to VDATA63. The second ladder resistance circuit 21 generates the same number of gradation potentials as the first ladder resistance circuit 20 and supplies the generated gradation potentials to a plurality of second nodes, respectively. Specifically, the second ladder resistance circuit 21 is formed by resistances r1 to r64 which divide the potential difference of the first power supply line VDD and the second power supply line VCOM and generate the gradation potentials VDATA0 to VDATA63. Note that the second ladder resistance circuit 21 has a resistance value lower than the first ladder resistance circuit 20. That is, the combined resistance of the resistances r1 to r64 has a resistance value lower than the combined resistance of the resistances R1 to R64. Moreover, between the first ladder resistance circuit 20 and the second ladder resistance circuit 21, the switches S1 to S64 are provided corresponding to all the gray levels. Accordingly, a plurality of the gradation potentials generated in the second ladder resistance circuit 21 are supplied to the plurality of first nodes of the first ladder resistance circuit 20. Here, the switches S1 to S64 are turned on only in the predetermined period among the period in which the gradation potentials selected by the decoder are supplied to pixels via the data lines 16 (see FIG. 12). Then, the second ladder resistance circuit 21 having a low resistance value is activated temporarily. As described above, by making the output impedance of the entire gradation potential generation circuit 14 low, the input of the voltage follower 15 can be promptly reached to the target voltage. That is, it is possible to supply stable gradation potentials by temporarily operating with high driving capability and rapidly charge and discharge the input of the voltage follower 15. Moreover, by turning off the switches S1 to S64, deactivating the second ladder resistance circuit 21 to operate only the first ladder resistance circuit 20, the increase of the power consumption can be slightly suppressed.

The output impedance of all the outputs VDATA0 to VDATA63 is calculated using the gradation potential generation circuit 14 disclosed in Japanese Unexamined Patent Application Publication No. 2005-37746. Here, a simulation has been performed with the ratio of a current I₁ flowing into the first ladder resistance circuit 20 and a current I₂ flowing into the second ladder resistance circuit 21 to be 1:4, using a MOS transistor as a switching device. FIG. 6 is a graph showing an output impedance (simulation value) of all the outputs VDATA0 to VDATA63 of the gradation potential generation circuit 14 disclosed in Japanese Unexamined Patent Application Publication No. 2005-37746. In FIG. 6, the vertical axis is the output impedance and the horizontal axis is VDATAn (n is integers from 0 to 63). By an influence of on resistances of each switch device (MOS transistor), the output impedance became the highest near the VDATA32. Specifically, in VDATA0 and VDATA63 which are supplied to the first node nearest to the first power supply line VDD or the second power supply line VCOM, the output impedance became low. Then, the output impedance became high as approaching toward the intermediate potential of the first and second power supply lines near VDATA32. As described above, in the gradation potential generation circuit 14 disclosed in Japanese Unexamined Patent Application Publication No. 2005-37746, the output impedance of the gradation potential becomes the highest near the intermediate potential of the first and second power supply lines.

From the above explanation, in the decoding circuit 13 of FIG. 10, when the gradation voltage near VDATA32 (a gradation potential near the intermediate potential of the first and second power supply lines) is selected as a gradation potential output to each voltage follower 15, the input of the voltage follower 15 cannot be discharged and charged at high speed. That is, when the gradation potential near VDATA32 is selected, it will take extremely longer the time for the input of the voltage follower 15 to reach the target voltage (delay time) as compared with the case when another gradation potential is selected. Thus, when the gradation potential near VDATA0 and VDATA63 is selected, the charge and discharge can be performed at high speed. However when the gradation potential near VDATA32 is selected, the charge and discharge will become extremely slow. Especially with the structure as the gradation potential generation circuit 14 of FIG. 11 where the first ladder resistance circuit 20 and the second ladder resistance circuit 21 have output nodes corresponding to all the gray levels and each of them are connected by the switches, the relation that the delay time of the gradation potential near the intermediate potential of the first and second power supply lines is the maximum does not change. Therefore, with the abovementioned structure, the maximum delay time cannot be shortened effectively. Accordingly, there is a possibility that writing shortage may arise to the pixel of the gradation potential near VDATA32 and to deteriorate the display quality. Moreover, the switches corresponding to all the gray levels greatly increase the circuit area of the gradation potential generation circuit 14.

Furthermore, as shown in FIG. 12, this gradation potential generation circuit 14 switches to activate and deactivate the second ladder resistance circuit 21 when the gradation potentials selected by the decoder are supplied to the pixels via the data lines 16. More specifically, the switches S1 to S64 are turned on and the second ladder resistance circuit 21 is activated at the same time the gradation potential selected by the decoding circuit 13 is supplied to the inputs t1 to t720 of the voltage follower 15 and the output voltage of the voltage follower 15 is output to the data lines 16. Then, the switches S1 to S64 are turned off after certain period and the second ladder resistance circuit 21 is deactivated. In this case, when changing the switches S1 to S64 from on to off, a switching noise is generated as an impedance suddenly becomes high. Then, since the switching noise is generated while a voltage is written to the pixels, display image quality deteriorates remarkably.

### SUMMARY

In one embodiment, a gradation potential generation circuit includes a first ladder resistance circuit supplied with a first and a second reference voltages to both ends to generate j number of gradation potentials (j is an integer of 2 or more) and output the generated j number of gradation potentials to j number of first nodes, where the j number of gradation potentials being generated by dividing the first and the second reference voltages, a second ladder resistance circuit to generate k number of gradation potentials out of the j number of gradation potentials (where j>k) generated by the first ladder resistance circuit and k number of switches to supply the k number of gradation potentials generated by the second ladder resistance circuit to k number of first nodes out of the j number of first nodes according to a first control signal.

This enables to distribute the difference of output impedance between gradations and reduce the maximum value of the output impedance. Moreover, by the second ladder resistance circuit generating some of the gradation potentials among the gradation potentials of the first ladder resistance circuit, the number of switches between the first and the second ladder resistance circuits is reduced. Moreover, the circuit area of the gradation potential generation circuit can be reduced or switch size can be increased for the reduction in the number of switches to further reduce the maximum value of the output impedance.

The present invention is able to offer the gradation potential generation circuit with suppressed difference of the output impedance between gradations. Moreover, it is also possible to reduce the circuit area. Furthermore, the present invention is able to offer the data driver of a high-speed drive and the display device with high display quality.

### BRIEF DESCRIPTION OF THE DRAWINGS

The above and other objects and advantages and features of the present invention will be more apparent from the following description of certain preferred embodiments taken in conjunction with the accompanying drawings, in which:

FIG. 1 is a block diagram showing the structure of a liquid crystal display device according to a first embodiment;

FIG. 2 is a block diagram showing the structure of a data driver IC according to the first embodiment;

FIG. 3 shows the structure of a decoding circuit according to the first embodiment;

FIG. 4 shows the structure of a gradation potential generation circuit according to the first embodiment;

FIG. 5 is a timing chart of the gradation potential generation circuit according to the first embodiment;

FIG. 6 is a graph showing an output impedance of all the outputs VDATA0 to VDATA63 of the gradation potential generation circuit according to the first embodiment and a gradation potential generation circuit according to a related art;

FIG. 7 is a block diagram showing the structure of a liquid crystal display device according to a second embodiment;

FIG. 8 is a block diagram showing the structure of a data driver IC according to the second embodiment;

FIG. 9 shows the structure of a gradation potential generation circuit according to the second embodiment;

FIG. 10 is a block diagram showing the structure of a data driver IC according to a related art;

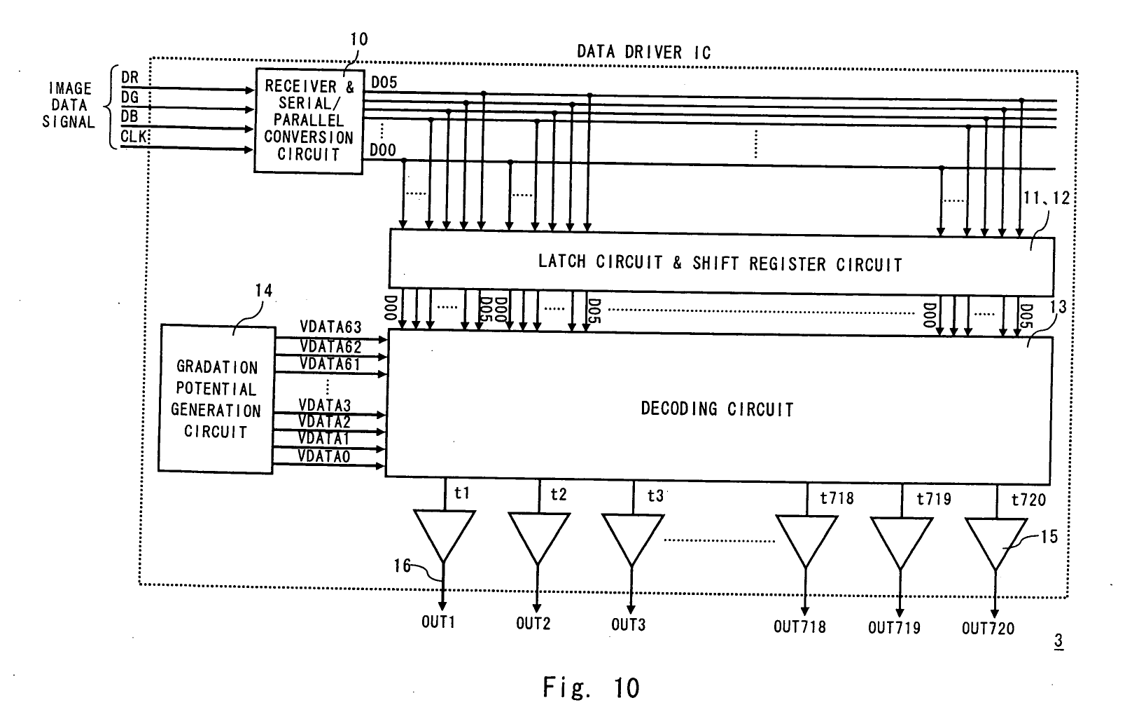

FIG. 11 shows the structure of a gradation potential generation circuit according to a prior art; and

FIG. 12 is a timing chart of the gradation potential generation circuit according to a related art.

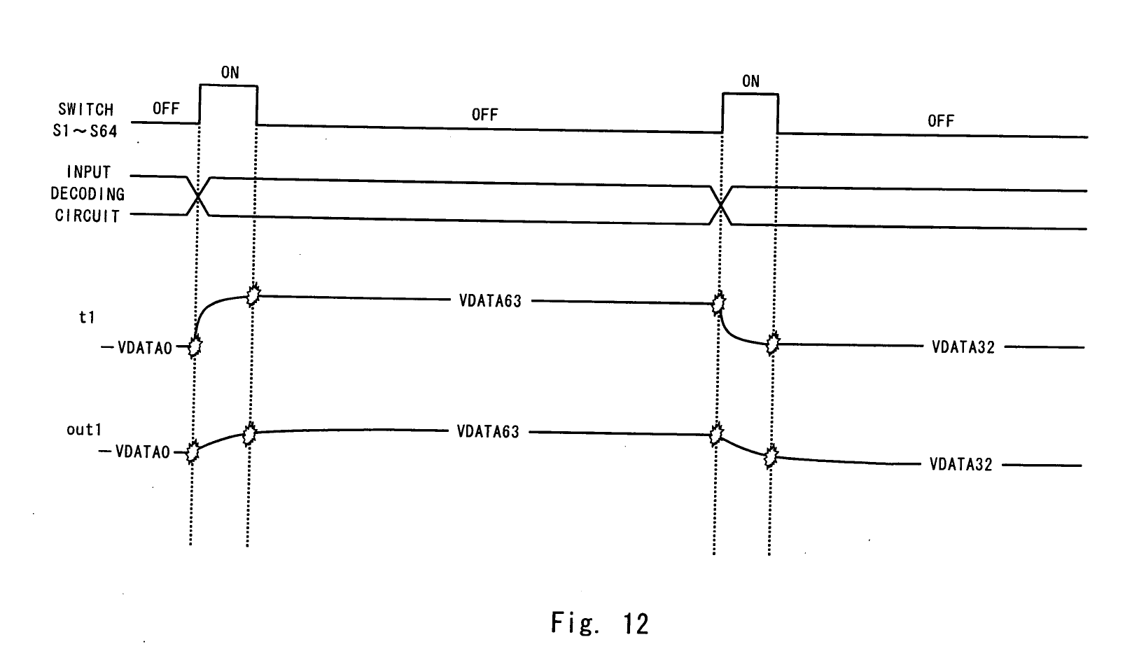

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

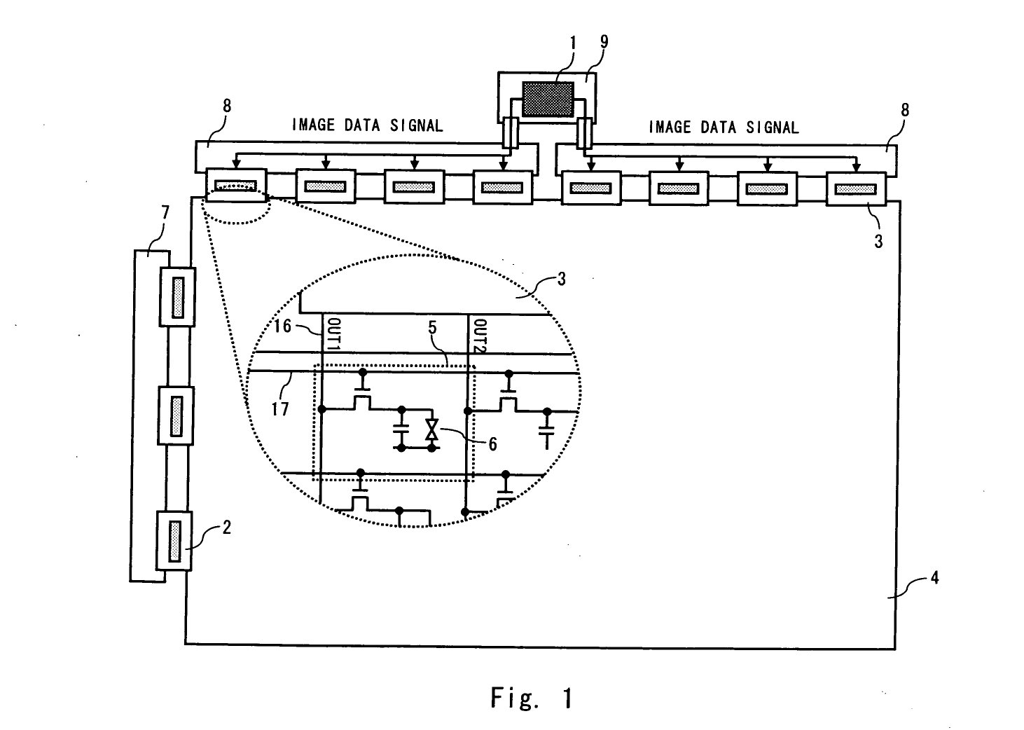

A display device according to this embodiment is explained with reference to FIG. 1. FIG. 1 is a block diagram showing the structure of a liquid crystal display device. The liquid crystal display device is formed by a timing controller IC 1, gate driver (gate side liquid crystal driving circuit) ICs 2, data driver (source side liquid crystal driving circuit) ICs 3 and a liquid crystal panel 4. A plurality of the gate driver ICs 2 are provided along with one side of the liquid crystal panel 4. Similarly, a plurality of the data driver ICs 3 are provided along with another one side of the liquid crystal panel 4. That is, the ends of the gate driver ICs 2 and the data driver ICs 3 are connected to the liquid crystal panel 4. Moreover, other ends opposing the ends of the gate driver ICs 2 and the data driver ICs 3 connected to the liquid crystal panel 4 are connected to substrates 7 and 8 such as a flexible printed circuit (FPC). The substrate 8 connected to the data driver ICs 3 is further connected to the timing controller IC 1 via a substrate 9. The gate driver ICs 2 sequentially output gate signals (scanning signal) for each gate line 17 according to a timing control signal input from the substrate 7. The data driver ICs 3 convert the digital image data signal sent from the timing controller IC 1 into analog voltage (gradation signal) and output it to data lines (out1, out2 etc.) 16. A pixel 5 of the liquid crystal panel 4 accumulates the gradation signal output to the data line 16 in a liquid crystal element 6 disposed in the pixel 5, when the gate line 17 is selected by the scanning signal. Then, the liquid crystal element 6 holds the gradation signal until the gate line 17 is selected next. Then a desired image can be displayed.

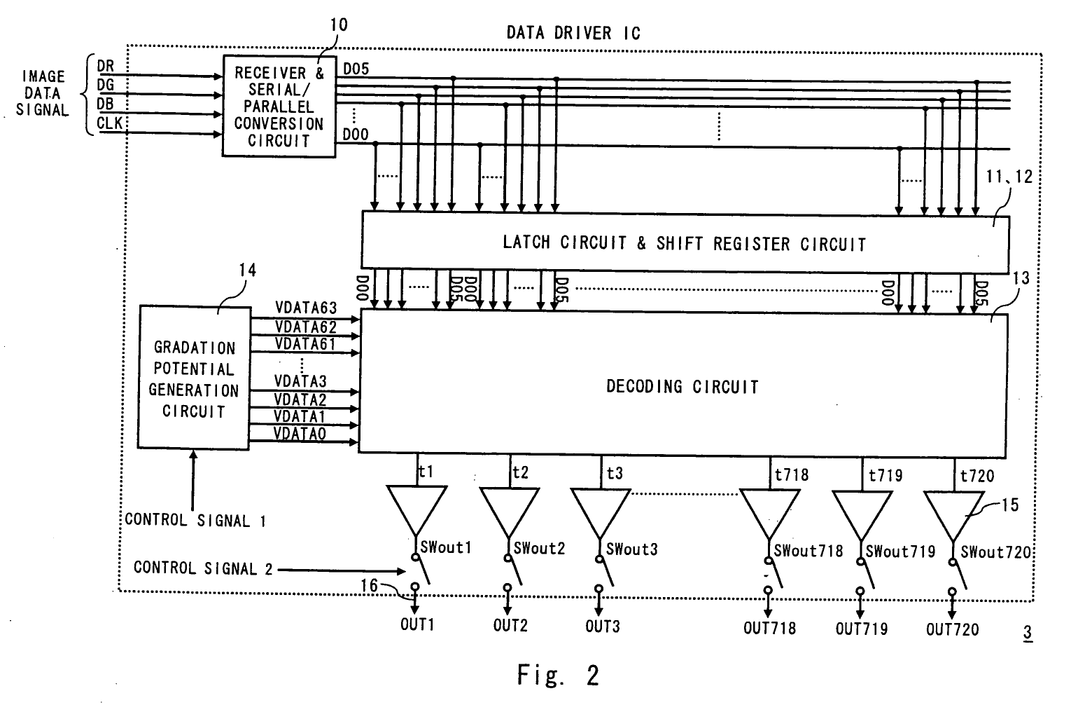

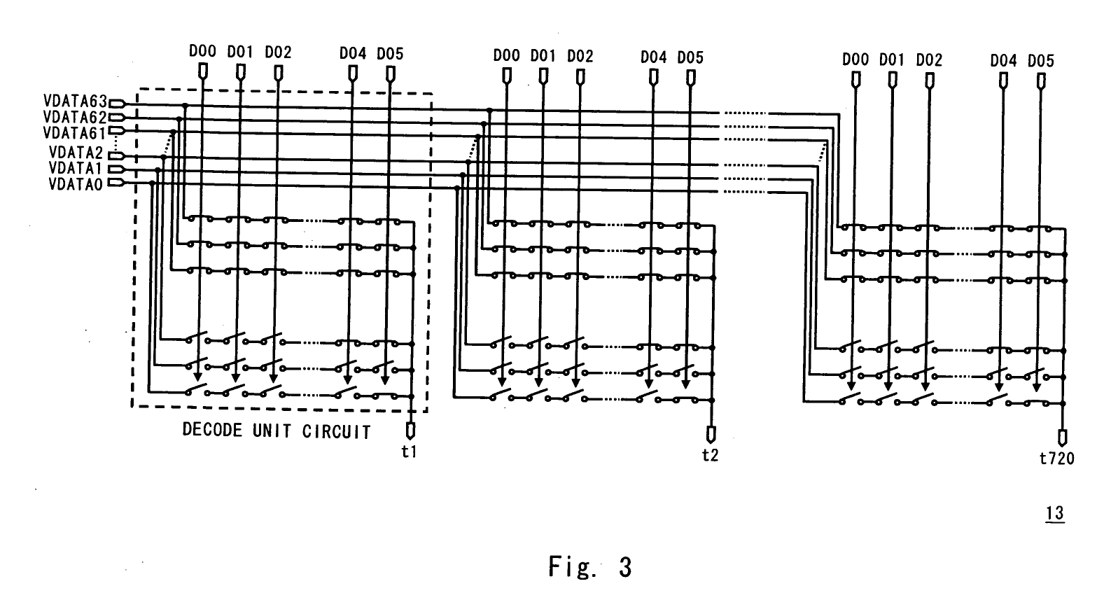

Next, the data driver IC 3 in this embodiment is explained with reference to FIGS. 2 and 3. FIG. 2 is a block diagram showing the structure of the data driver IC 3. The data driver IC 3 includes a receiver & serial/parallel conversion circuit 10, a latch circuit 11, a shift register circuit 12, a decoding circuit 13, a gradation potential generation circuit 14, a voltage follower (amplifier circuit) 15 and output switches SWout1 to SWout720. Here, 6-bit of the data driver IC 3 is explained as an example. Therefore, the gradation potential generation circuit 14 generates 64 gradation potentials of VDATA0 (gray level 0) to VDATA63 (gray level 63). Moreover, the number of outputs is set to 720 and 720 of the voltage followers 15 and the switches SWout1 to SWout720 are provided respectively.

An image data signal sent from the controller IC 1 is firstly input into the receiver & serial/parallel conversion circuit 10. Thus, according to a clock signal CLK, each data of the image data signals DR, DG and DB is supplied. The receiver & serial/parallel conversion circuit 10 receives the serial image data signals sent from the timing controller IC 1 and converts into parallel data D00 to D05 for each output unit. The parallel data D00 to D05 converted by the receiver & serial/parallel conversion circuit 10 is sequentially transmitted by the shift register circuit 12 according to the number of data lines. This parallel data D00 to D05 is input and stored sequentially in the latch circuit 11 provided for every output unit and output to the decoding circuit 13 all at once at a predetermined timing. The gradation potentials VDATA0 to VDATA63 output from the gradation potential generation circuit 14 are input to the decoding circuit 13. Then, the gradation potentials corresponding to the digital gradation data D00 to D05 output from the latch circuit 11 are selected for every output unit from the input gradation potentials VDATA0 to VDATA63. The gradation potentials selected for every output unit are output to the inputs t1 to t720 of the voltage follower 15, respectively. The voltage follower 15 amplifies the current of the gradation potentials selected by the decoding circuit 13 and outputs the amplified gradation potentials to the data lines 16 via the output switches SWout1 to SWout720 which are controlled by a control signal 2. Note that a control signal 1 is input into the gradation potential generation circuit 14 to control the output impedance of the gradation potential generation circuit 14, which is, the current supply capability of the gradation potentials VDATA0 to VDATA63.

Moreover, an example of the structure of the decoding circuit 13 is shown in FIG. 3. The decoding circuit 13 shown in FIG. 3 includes 720 decoding unit circuits corresponding to the number of outputs. The gradation potentials VDATA0 to VDATA63 are shared by 720 decoding unit circuits. Each decoding unit circuit can be formed by 6 switching devices in series that are each input with the digital gradation data D00 to D05 to a control end. The gradation potentials VDATA0 to VDATA63 are supplied respectively to one ends of the six switching devices in series and another ends are connected commonly to be connected to the input of the voltage followers 15. On and off of the switching devices are controlled by the digital gradation data D00 to D05 sent from the latch circuit 11. Then, among the gradation potentials VDATA0 to VDATA63, the gradation potentials with all the six switching devices set to on are output to the inputs t1 to t720 of the voltage follower 15, respectively. Note that the structure of the decoding circuit 13 may be other than the one shown in FIG. 3.

As for the output switches SWout1 to SWout720 shown in FIG. 2, on and off are controlled by the control signal 2. Then, in the case of on, the outputs of the voltage followers 15 is connected with the data lines 16 and gradation potentials (gradation signal) are supplied to the data lines 16. Moreover, in the case of off, the data lines 16 and the outputs of the voltage followers 15 are separated. That is, the data driver IC 3 and the liquid crystal panel 4 are separated electrically. Note that when data switches for every data output period, a signal noise is generated in the decoding circuit 13 or the like. In order to prevent from outputting this signal noise to the data lines 16, the output switches SWout1 to SWout720 are turned off from the start of the data output period to the predetermined period and the data lines 16 and the voltage followers 15 are separated. This is because that there is a possibility that the signal noise transmitted to the data line influences the writing voltage to a pixel and thus the display image quality may deteriorate. Therefore, in the data driver IC 3 of the liquid crystal display device, it is common to have an electric cutting means between the voltage follower 15 and the data line 16 like the abovementioned output switches SWout1 to SWout720.

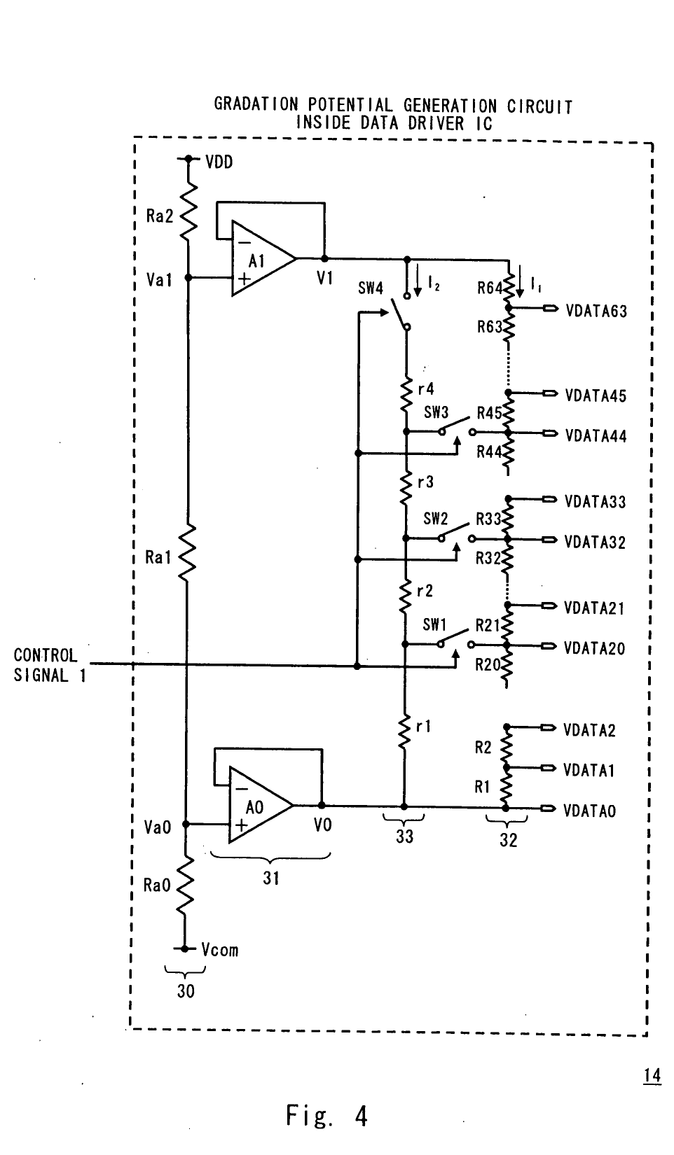

Next, the abovementioned gradation potential generation circuit 14 is explained in detail with reference to FIG. 4. FIG. 4 shows the structure of the gradation potential generation circuit 14. The gradation potential generation circuit 14 is formed by a first power supply line VDD, a second power supply line VCOM, a third ladder resistance circuit 30, an amplifier circuit 31, a first ladder resistance circuit 32, a second ladder resistance circuit 33 and switches SW1 to SW4.

The third ladder resistance circuit 30 is formed by the resistance Ra0 to Ra2 in series which divide the potential difference of the first power supply line VDD and the second power supply line VCOM and generate voltages Va0 and Va1. Ra2 is connected to the first power supply line VDD side and Ra0 is connected to the second power supply line VCOM side. Then, a third node is provided at the connection point of each resistance. The amplifier circuit 31 includes an amplifier A0 and an amplifier A1 which are connected between the third ladder resistance circuit 30 and the second ladder resistance circuit 33. The amplifier A0 is input with the voltage Va0 and outputs a reference voltage V0. The amplifier A1 is input with the voltage Va1 and outputs a reference voltage V1.

First and second reference voltages (reference voltages V0 and V1 in this example) output from the amplifier circuit 31 are supplied to both ends of the first ladder resistance circuit 32. Then, the first ladder resistance circuit 32 is formed by the resistances R1 to R64 in series divide the reference voltages V0 and V1 and generate the gradation potentials VDATA0 to VDATA63. R64 is connected to the reference voltage V1 side and R1 is connected to the reference voltage V0 side. Then, first nodes are provided to the connection points of the resistances R1 to R64 and a supply terminal of the reference voltage V0 by the side of R1. That is, the gradation potentials VDATA0 to VDATA63 generated by the voltage division of the resistances R1 to R64 are output to 64 of the first nodes, respectively. Note that the gradation potentials generated by the first ladder resistance circuit 32 may also include at least one of the first and second reference voltages. The second ladder resistance circuit 33 is formed by the resistances r1 to r4 in series which divide the reference voltages V0 and V1 and generate 4 gradation potentials VDATA0, VDATA20, VDATA32 and VDATA44. r4 is connected to the reference voltage V1 side via switch SW4, and r1 is connected to the reference voltage V0 side. Then, second nodes are provided at the connection points of the resistances r1 to r4. Switches SW1 to SW3 are connected respectively between the connection points (3 second nodes) of the resistances r1 to r4 for outputting the gradation potentials VDATA20, VDATA32 and VDATA44 and the connection points (3 first nodes) for outputting the gradation potentials VDATA20, VDATA32 and VDATA44 of the first ladder resistance circuit 32. The on/off control of the switches SW1 to SW3 and SW4 is controlled by the control signal 1. Then, the output impedance of the gradation potential generation circuit 14 can be lowered by turning the switches SW1 to SW4 to on. At this time, it is desirable to design so that the combined resistance of the resistances r1 to r4 of the second ladder resistance circuit 33 may have a lower resistance value than the combined resistance of the resistances R1 to R64 of the first ladder resistance circuit 32. Moreover, when the switches SW1 to SW4 are turned off, the output impedance of the gradation potential generation circuit 14 becomes high, however as the current flowing into the second ladder resistance circuit 33 is blocked, the power consumption of the gradation potential generation circuit 14 becomes low. By appropriately controlling on/off of the switches SW1 to SW4, it is possible to achieve the structure of low power consumption and low output impedance for the gradation potential generation circuit 14.

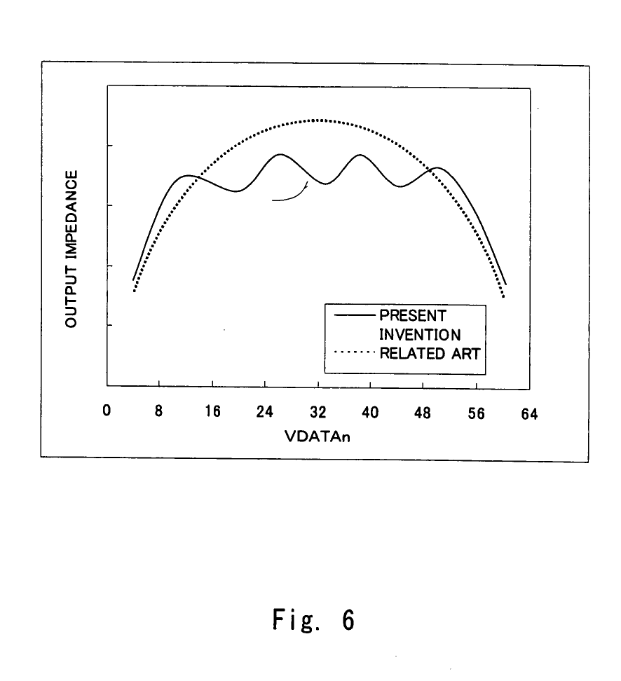

In this embodiment, the second ladder resistance circuit 33 generates some of the gradation potentials among the gradation potentials generated by the first ladder resistance circuit 32. Note that the gradation potentials generated by the second ladder resistance circuit 33 may not include the reference voltage and may generate 1 or more of gradation potentials. In addition, when forming so that 2 or more of gradation potentials may be generated, a potential difference between adjacent gradation potentials is made to be large near the reference voltages V0 and V1 and a potential difference between adjacent gradation potentials is made to be small near the intermediate voltage of the reference voltages V0 and V1. For example in FIG. 4, among the gradation potentials VDATA20, VDATA32 and VDATA44 generated by the second ladder resistance circuit 33, for VDATA20 and VDATA44, a potential difference between VDATA20 and VDATA32 and a potential difference between VDATA44 and VDATA32 near the intermediate voltage of the reference voltages V0 and V1 ((VDATA32-VDATA20) and (VDATA44-VDATA32)) are both made to be smaller than a potential difference between VDATA20 and the reference voltage V0 and a potential difference between VDATA44 and the reference voltage V1 ((VDATA20-V0) and (V1-VDATA44)). Accordingly, when the switches SW1 to SW4 are turned on, the difference of the output impedances between gradations can be distributed and the maximum value of the output impedance of the gradation potential generation circuit 14 can be reduced significantly. This advantageous effect is described later with reference to FIG. 6.

Moreover, the on/off control of the switches SW1 to SW4 of the gradation potential generation circuit 14 is cooperated with the on/off control of the output switches SWout1 to SWout720 provided between the output ends of the voltage followers 15 and the data lines 16 of the data driver IC 3 shown in FIG. 2. More specifically, the switches SW1 to SW4 of the gradation potential generation circuit 14 are set to on only in the period when the output switches SWout1 to SWout720 are set to off and the output ends of the voltage followers 15 and the data lines 16 are electrically disconnected. The switches SW1 to SW4 of the gradation potential generation circuit 14 are set to off in the period when the output switches SWout1 to SWout720 are set to on and the output ends of the voltage followers 15 and the data lines 16 are connected. This is because that when the switches SW1 to SW4 of the gradation potential generation circuit 14 are switched from off to on or from on to off, the output impedance of the gradation potential generation circuit 14 changes and a noise is generated in the gradation potentials VDATA0 to VDATA63 which are output from the gradation potential generation circuit 14. The abovementioned control of the output switches SWout1 to SWout720 and the switches SW1 to SW4 is aimed to prevent the gradation potentials VDATA0 to VDATA63 including this noise from being transmitted to the data lines 16 via the decoding circuit 13 and the voltage followers 15.

In FIG. 4, the 6-bit data driver IC 3 of the gradation potential generation circuit 14 is shown as an example of the gradation potential generation circuit 14 of this embodiment, however it is not limited to this. For example, the third ladder resistance circuit 30 of the gradation potential generation circuit 14 may be formed by resistances Ra0 to Ra (i+1) which divide the potential difference of the first power supply line VDD and the second power supply line VCOM and generate voltages Va0 to Vai. Note that i is an integer value of 1 or more. Then, the amplifier circuit 31 includes amplifiers A0 to Ai, input with the voltages Va0 to Vai generated by the third ladder resistance circuit 30 and outputs as reference voltages V0 to Vi. The first ladder resistance circuit 32 is formed by resistances R1 to Rj which divide the reference voltages V0 to Vi of the amplifier circuit 31 and generate gradation potentials VDATA0 to VDATA (j-1), which is j number of the gradation potentials. Note that j is an integer value of 2 or more. The second ladder resistance circuit 33 is formed by resistances r1 to rk which divide the reference voltages V0 to Vi of the amplifier circuit 31 and generate only some of the gradation potentials among the gradation potentials generated by the first ladder resistance circuit 32. Accordingly, k number of gradation potentials are generated. For the gradation potentials generated by the second ladder resistance circuit 33, near the reference voltages V0 to Vi, a potential difference between adjacent gradation potentials may be made large and a potential difference between adjacent gradation potentials near the intermediate voltage of the 2 reference voltages may be made small. Note that k is an integer value of 1 or more. In addition, the resistances r1 to rk of the second ladder resistance circuit 33 have resistance values lower than the resistances R1 to Rj of the first ladder resistance circuit 32. Switches SW1 to SWk plays a role to supply the gradation potentials generated by the second ladder resistance circuit 33 to the first nodes of the first ladder resistance circuit 32. As described above, although the 6-bit of the data driver IC 3 is explained as an example, it can be applied to the gradation potential generation circuit 14 of the data driver IC 3 of various numbers of bits. Needless to say that according to number of bits, the digital gradation data D00 to D05 shown in FIGS. 2 and 3 are appropriately changed. In this embodiment, it may be k<j, meaning that the number of switches SW may be smaller than the number of gradation potentials. Thus, as in a related art, the switching devices are not provided corresponding to all the gradation potentials. Note that in 6-bit data driver IC 3 shown in FIGS. 2 to 4, i=1, j=64 and k=4.

Since the second ladder resistance circuit 33 in this embodiment generates some of the gradation potentials among the gradation potentials of the first ladder resistance circuit 32, the number of switching devices can be reduced. Thus, if the gradation potential generation circuit 14 is manufactured with the same area as in a related art, the size of the switching devices can be increased because of the reduction in the number of the switching devices. Accordingly, on resistance of the switching devices can be reduced. Therefore, the influence by the on resistance of the switching devices can be reduced and for the gradation potentials with high output impedance of the first ladder resistance circuit 32, the output impedance can be effectively reduced. Accordingly, the maximum delay amount for the charge and discharge of the input of the voltage follower 15 to the target voltage can be reduced. Then, gradation potentials can be output stably.

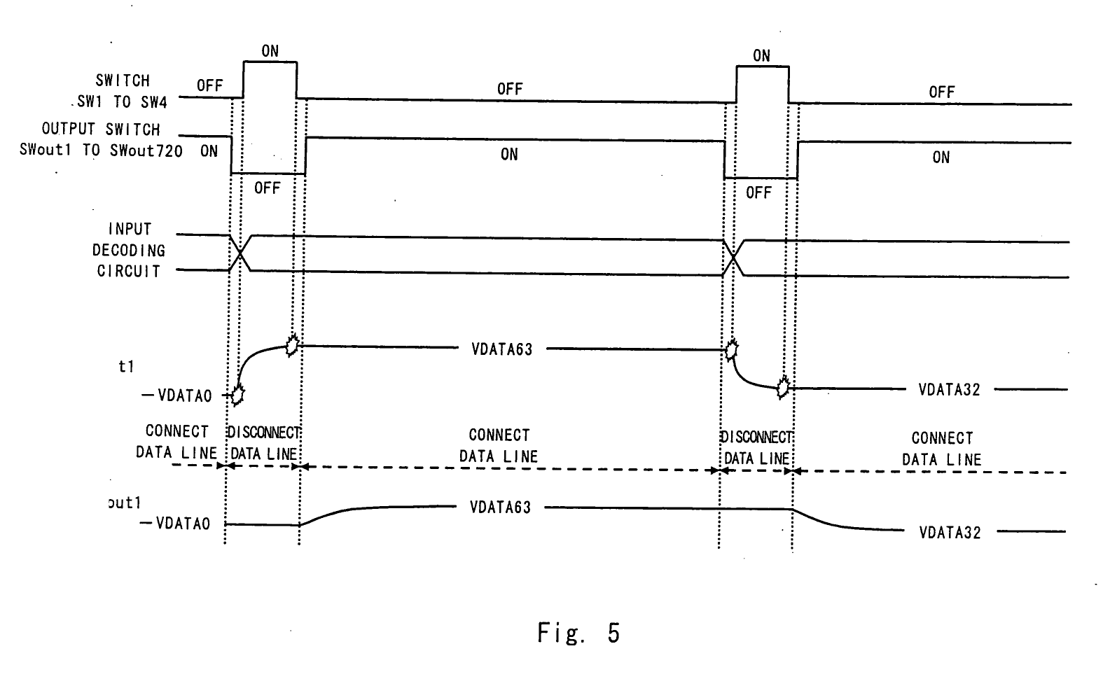

The operation timing of the switches SW1 to SW4 and the output switches SWout1 to SWout720 of the gradation potential generation circuit 14 in 1 data output period, which is, one selection period when gradation potentials are selected is explained with reference to FIG. 5. FIG. 5 is a timing chart of the gradation potential generation circuit 14 according to this embodiment. Note that as an example, the timing chart of the gradation potential generation circuit 14 shown in FIG. 4, which is i=1, j=64 and k=4 is shown here. Immediately before turning on the switches SW1 to SW4, the output switches SWout1 to SWout720 are turned off. This separates between the data lines 16 and the output ends of the voltage followers 15. Then, at the timing when the digital gradation data D00 to D05 is output from the latch circuit 11 to the decoding circuit 13, the switches SW1 to SW4 are turned on to drive the second ladder resistance circuit 33. Accordingly, the output impedance of the gradation potential generation circuit 14 is reduced and the gradation potentials VDATA0 to VDATA63 are output with high current driving capability from the gradation potential generation circuit 14. Moreover, in the decoding circuit 13, the gradation potentials corresponding to the digital gradation data D00 to D05 are selected from the gradation potentials VDATA0 to VDATA63. Then, the inputs t1 to t720 of the voltage follower 15 are respectively charged and discharged to the selected gradation potentials at high speed. After certain period, the gradation potential generation circuit 14 turns off the switches SW1 to SW4, stops the second ladder resistance circuit 33 and operates only the first and the third ladder resistance circuits 32 and 30. This enables to suppress the increase in power consumption. Immediately after that, the output switches SWout1 to SWout720 are turned on and the gradation potentials amplified and output by the voltage followers 15 are promptly supplied to the pixels 5 via the data lines (out1 to out720) 16. That is, the switches SW1 to SW4 are turned on while the output switches SWout1 to SWout720 are off.

Thus, in 1 data output period, the period when the output switches SWout1 to SWout720 are off is referred to as a first period and the period afterward, which is the period when the output switches SWout1 to SWout720 are on, is referred to as a second period. In this case, the switches SW1 to SW4 are set to on in a predetermined period within the first period and set to off in the second period. These operations are performed for each gate line. Then, by sequentially scanning all the gate lines, a desired image is displayed. Moreover, the first period to turn off the output switches SWout1 to SWout720 may be conformed to the period to turn on the switches SW1 to SW4. Furthermore, the period to turn on the switches SW1 to SW4 may be shorter than the first period. Accordingly, in the first period to turn off the output switches SWout1 to SWout720, the input of the voltage follower 15 can be changed to the newly selected gradation potential at high speed in the predetermined period to turn on the switches SW1 to SW4. Then, an output signal of the voltage follower 15 can also be changed to the newly selected gradation potential at high speed. Moreover, it is possible to prevent a switching noise which is caused by on/off of the switches SW1 to SW4 between the first and the second ladder resistance circuits from being transmitted to the data lines 16. On the other hand, in the second period to turn on the output switches SWout1 to SWout720, the switches SW1 to SW4 are set to off. Then, the output signal of the voltage followers 15 is promptly supplied to the data lines 16 via the output switches SWout1 to SWout720 set to on.

As mentioned above, in the gradation potential generation circuit 14 according to this embodiment, the switch between the activation and the deactivation of the second ladder resistance circuit 33 is performed while the data lines 16 are separated. Accordingly, a switching noise by the switches SW1 to SW4 does not transmit to the pixels 5 and does not affect display image quality. Note that the second ladder resistance circuit 33 is used as an output impedance reduction operation of the gradation potential generation circuit 14 and it is configured not to influence at all to the output of the gradation potentials to the data lines 16. Therefore, the gradation potentials output from the second ladder resistance circuit 33 does not necessarily need to have high voltage accuracy and the resistance design with fine area efficiency is possible for the second ladder resistance circuit 33. As mentioned above, according to the data driver IC 3 of this embodiment, it is possible to suppress from increasing the output impedance and output stable gradation potentials.

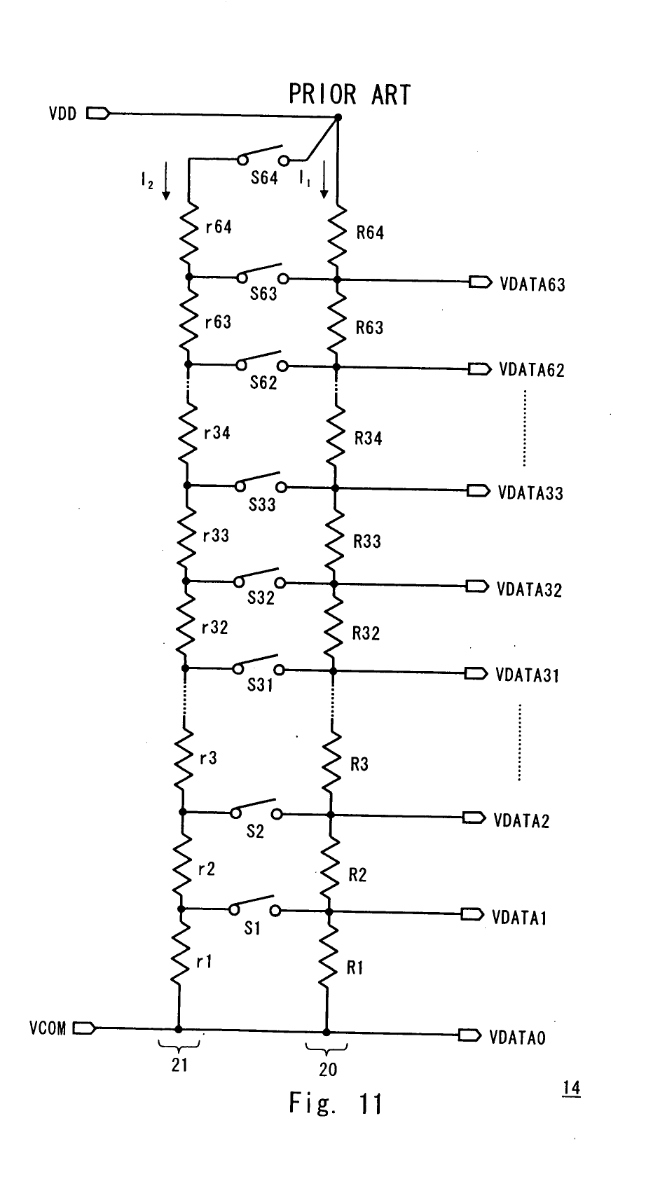

Next, the comparison result of the calculation of the output impedance for all the outputs VDATA0 to VDATA63 using the gradation potential generation circuit 14 according to the present invention and the gradation potential generation circuit 14 of a related art is explained. Note that as the gradation potential generation circuit 14 of a related art, the gradation potential generation circuit 14 disclosed in Japanese Unexamined Patent Application Publication No. 2005-37746 is used. Here, a MOS transistor is used as a switching device and as for the current flowing into the first and the second ladder resistance circuits, the current amount is made equal between the present invention and the related art. In the prior art shown in FIG. 11, the ratio between the current I₁ flowing into the first ladder resistance circuit 20 and the current I₂ flowing into the second ladder resistance circuit 21 is made to be 1:4. In the present invention shown in FIG. 4, the ratio between the current I₁ flowing into the first ladder resistance circuit 32 and the current I₂ flowing into the second ladder resistance circuit 33 is made to be 1:4. The simulations are performed under the above conditions. Since the number of the switching devices of the gradation potential generation circuit 14 in the present invention (FIG. 4) is 1/16 of the structure of the related art, the size of the switching devices is made to be 16 times of the structure of the related art. Note that the area of the gradation potential generation circuit 14 is equal. FIG. 6 is a graph showing an output impedance (simulation value) of all the outputs VDATA0 to VDATA63 of the gradation potential generation circuit 14 according to the present invention and the gradation potential generation circuit 14 according to the related art. In FIG. 6, the vertical axis is the output impedance and the horizontal axis is VDATAn (n is integers from 0 to 63). From the simulation result, it can be seen that the impedance near the VDATA32 can be made small in the present invention, whereas in the structure of the related art, the impedance has been extremely high near VDATA32. Moreover, it can be confirmed that the maximum value of the output impedance can be made small. Note that in the portion of VDATA20, VDATA32 and VDATA44, the output impedance became lower than the surrounding portion of VDATAn. This is because that the switches SW1 to SW4 are provided corresponding to the gradation potentials VDATA20, VDATA32 and VDATA44 and to drive the second ladder resistance circuit 33 having a low resistance value. Note that VDATA20, VDATA32 and VDATA44 are provided closer to the intermediate voltage of the 2 reference voltages input into the both ends of the ladder resistance circuit. Thus, the gradation potential generation circuit 14 of the present invention can distribute the difference of the output impedance between gradations and also to suppress the maximum delay amount of the output impedance. This enables to charge and discharge the input of the voltage follower 15 at high speed whichever the voltage is selected. Therefore, as compared with the gradation potential generation circuit 14 of the related art, it is possible to achieve the gradation potential generation circuit 14 with small maximum delay amount by the same area and power consumption.

### Second Embodiment

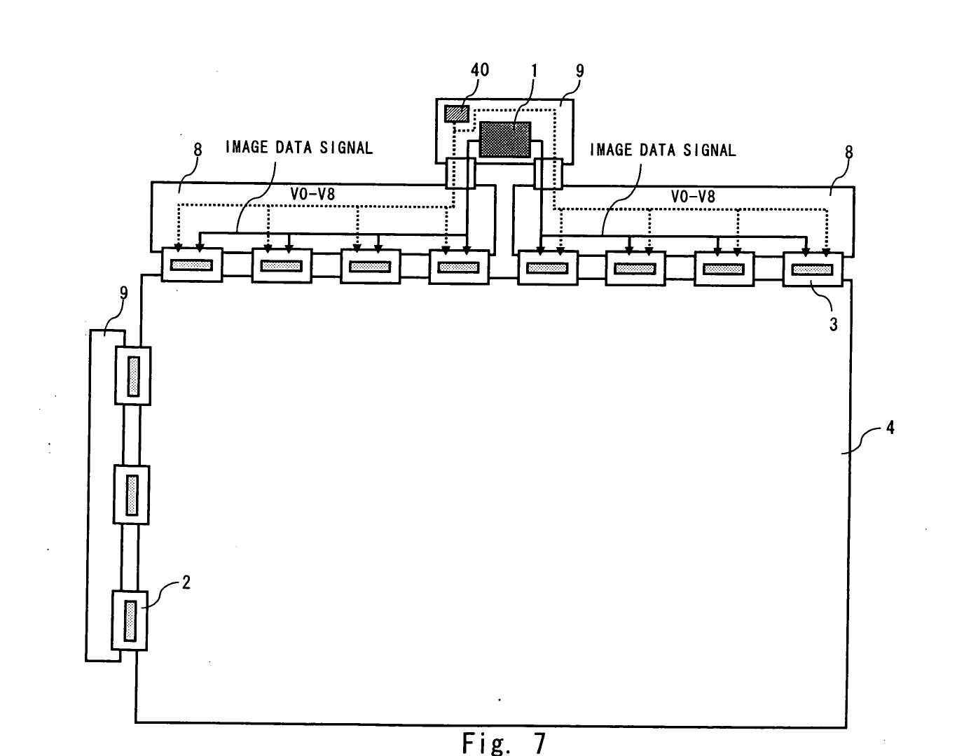

As a display device according to this embodiment, a liquid crystal display device can be used as with the first embodiment. The liquid crystal display device according to this embodiment is explained with reference to FIG. 7. FIG. 7 is a block diagram showing the structure of the liquid crystal display device. The liquid crystal display device is formed by a timing controller IC 1, gate driver ICs 2, data driver ICs 3, a liquid crystal panel 4 and a reference potential generation IC 40. Note that the components in the liquid crystal display device of this embodiment other than the reference potential generation IC 40 are same as the first embodiment, thus the explanation is omitted. In this embodiment, the reference potential generation IC 40 for generating reference potentials V0 to V8 is included. Then, common V0 to V8 are supplied to each data driver ICs 3 via substrates 9 and 8 of the liquid crystal display device.

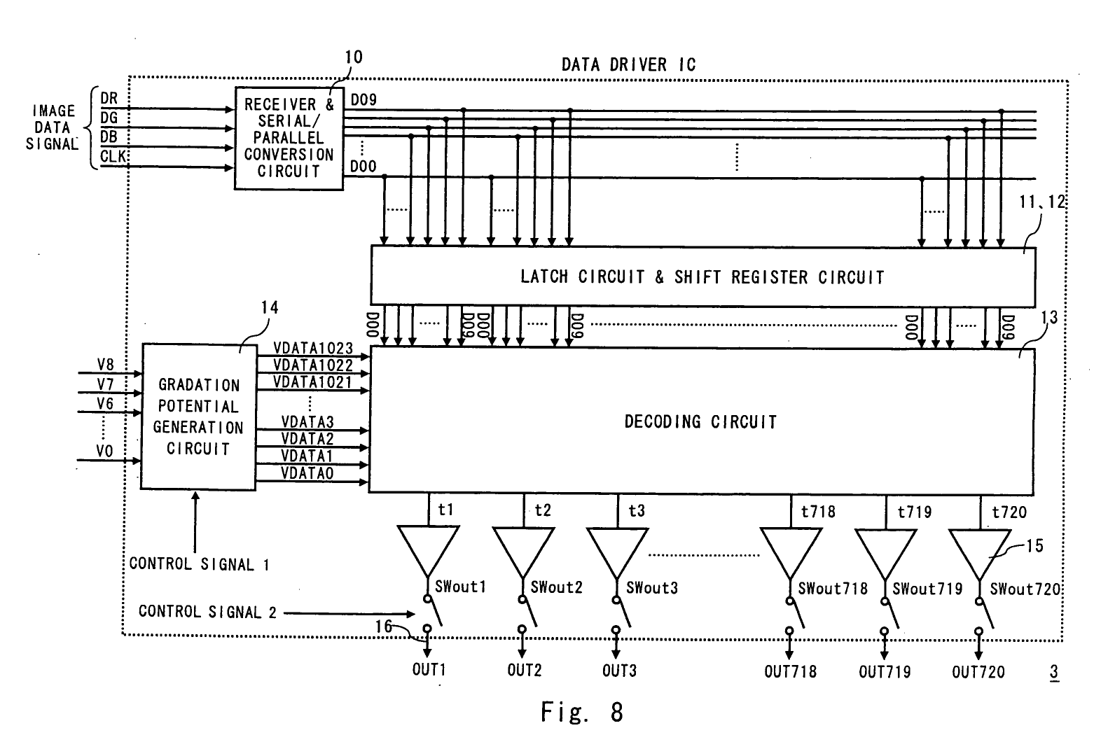

Next, the data driver IC 3 is explained with reference to FIG. 8. FIG. 8 is a block diagram showing the structure of the data driver IC 3. As with the first embodiment, the data driver IC 3 has a receiver & serial/parallel conversion circuit 10, a latch circuit 11, a shift register circuit 12, a decoding circuit 13, a gradation potential generation circuit 14 and output switches SWout1 to SWout720. Here, a 10-bit of the data driver IC 3 is explained as an example. That is, the gradation potential generation circuit 14 generates 1024 gradation potentials of VDATA0 to VDATA1023. Moreover, explanation is omitted for the part common in the first embodiment.

Here, since it is 10 bits, the receiver & serial/parallel conversion circuit 10 outputs parallel data D00 to D09. The reference potentials V0 to V8 generated by the reference potential generation IC 40 are input into the gradation potential generation circuit 14. That is, V0 to V8 are not generated by each data driver IC 3 and the common reference potentials V0 to V8 generated by the reference potential generation IC 40 are input into the gradation potential generation circuit 14 of each data driver IC 3. Then, the gradation potential generation circuit 14 generates the gradation potentials VDATA0 to VDATA1023 according to the reference potentials V0 to V8 and outputs them to the decoding circuit 13. Note that the output impedance of the gradation potential generation circuit 14 is controlled by a control signal 1 input. Then, the decoding circuit 13 selects the gradation potentials corresponding to the digital gradation data D00 to D09 output from the latch circuit 11 for every output unit from the gradation potentials VDATA0 to VDATA1023 and outputs them to the inputs t1 to t720 of the voltage followers 15, respectively. If the output switches SWout1 to SWout720 are set to on with a control signal 2, a current of a gradation signal (gradation potential) is amplified by the voltage followers 15. The amplified gradation signal is supplied to the data lines 16.

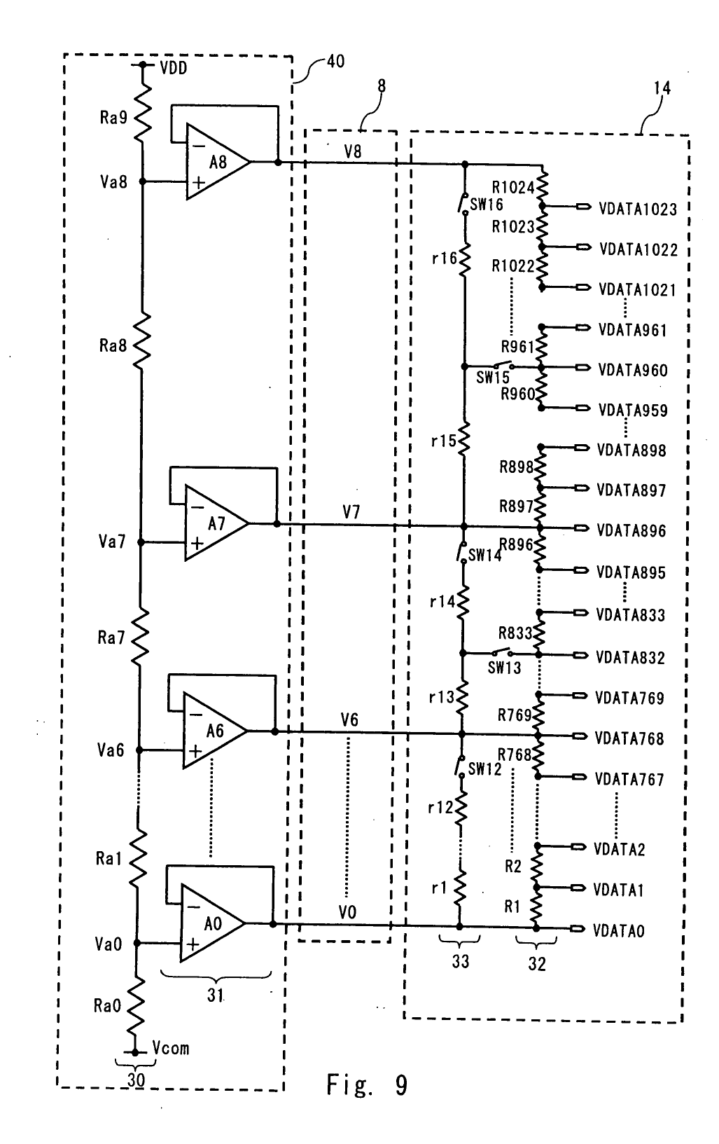

Next, the gradation potential generation circuit 14 is explained with reference to FIG. 9. FIG. 9 is a block diagram showing the structure of the gradation potential generation circuit 14 in the data driver IC 3.

The reference potential generation IC 40 is formed by a first power supply line VDD, a second power supply line VCOM, a third ladder resistance circuit 30 and an amplifier circuit 31. The third ladder resistance circuit 30 is formed by resistances Ra0 to Ra9 in series which divide the potential difference of the first power supply line VDD and the second power supply line VCOM and generate voltages Va0 to Va8. Ra9 is connected to the first power supply line VDD side and Ra0 is connected to the second power supply line VCOM side. Then, a third node is provided at the connection point of each resistance. The amplifier circuit 31 includes amplifiers A0 to A8 connected to the third nodes of the third ladder resistance circuit 30. The amplifier A0 is input with the voltage Va0 generated by the third ladder resistance circuit 30 and outputs as a reference voltage V0. Similarly, the amplifiers A1 to A8 are input with the voltages Va1 to Va8 generated by the third ladder resistance circuit 30 respectively and output as reference voltages V1 to V8. V0 to V8 which are output are input into the gradation potential generation circuit 14 in the data driver IC 3 via the substrate 8.

The gradation potential generation circuit 14 is formed by a first ladder resistance circuit 32, a second ladder resistance circuit 33 and switches SW1 to SW16. Note that basic structure of the first ladder resistance circuit 32, the second ladder resistance circuit 33 and the switches SW1 to SW16 are the same as that of the first embodiment. The first ladder resistance circuit 32 is formed by resistances R1 to R1024 in series which divide the reference voltages V0 to V8 output by the amplifier circuit 31 and generate the gradation potentials VDATA0 to VDATA1023. R1024 is connected to the reference voltage V8 side and R1 is connected to the reference voltage V0 side. Then, first nodes are provided to the connection points of the resistance R1 to R1024 and a supply terminal of the reference voltage V0 by the side of R1. Thus, the gradation potentials VDATA0 to VDATA1023 generated by the voltage division of the resistances R1 to R1024 are output to 1024 of the first nodes respectively. The second ladder resistance circuit 33 generates some of the gradation potentials among the 1024 gradation potentials generated by the first ladder resistance circuit 32. Here, only the gradation potentials near the intermediate voltage between the reference voltages V0 to V8 with high impedance are generated. Specifically, the second ladder resistance circuit 33 is formed by resistances r1 to r16 in series which divide the reference voltages V0 to V8 output by the amplifier circuit 31 and generate only the gradation potentials (for example, VDATA768, VDATA832 and VDATA896) corresponding to the first node with high output impedance. Note that as for the second ladder resistance circuit 33, it is desirable to form with a resistance value lower than the first ladder resistance circuit 32. That is, the combined resistance of the resistances r1 to r16 has a resistance value lower than the combined resistance of the resistances R1 to R1024. In the second ladder resistance circuit 33, r16 is connected to the reference voltage V8 side and r1 is connected to the reference voltage V0 side. Then, second nodes are provided at the connection points of the resistances r1 to r16. Moreover, the second node is provided also to a supply terminal of the reference voltage V0 by the side of r1. Then, the gradation potentials VDATA0, VDATA768, VDATA832 and VDATA896 or the like are output to the second nodes, respectively.

The switches SW13 and SW15 are provided so that the first node of the first ladder resistance circuit 32 and the second node of the second ladder resistance circuit 33 may be connected. For example, the second node between the resistances r13 and r14 of the second ladder resistance circuit 33 are connected to the first node between the resistances R832 and R833 of the first ladder resistance circuit 32 via the switch SW13. Moreover, the switches SW1, SW3, SW5, SW7, SW9 and SW11 are provided similarly, which are not shown. That is, the switches SW1, and SW3, . . . and SW15 are provided corresponding to a part of the gradation potentials generated by the second ladder resistance circuit 33. Moreover, the switches SW12, SW14 and SW16 are provided between the second node of the second ladder resistance circuit 33 input with the reference voltages V0 to V8 and the resistances r12, r14 and r16 on the side of the reference voltage V0 of the second node. For example, the switch SW12 is provided between the second node input with the reference voltage V6 and the resistance r12. Moreover, the switches SW2, SW4, SW6, SW8 and SW10 are provided similarly, which are not shown. Then, by turning on these switches SW1 to SW16 during the predetermined period, a current I₂ flows into the second ladder resistance circuit 33 to activate and the gradation potentials generated by the second ladder resistance circuit 33 are supplied to the first node of the first ladder resistance circuit 32. Therefore, the first node is always connected with the decoding circuit 13 to supply the gradation potentials. On the other hand, the second nodes are connected only in the period while the switches SW1 to SW16 are on.

Moreover, on/off switching of the switches SW1 to SW16 of the gradation potential generation circuit 14 is performed while the output switches SWout1 to SWout720 are set to off, which are provided between the data lines 16 and the voltage followers 15 in the data driver ICs 3 shown in FIG. 8. That is, while switching on and off of the switches SW1 to SW16 of the gradation potential generation circuit 14, the output switches SWout1 to SWout720 electrically separates between the data lines 16 and the output ends of the voltage followers 15. Here, the switches SW1 to SW16 are turned on while the output switches SWout1 to SWout720 are set to off. That is, the switches SW1 to SW16 and the output switches SWout1 to SWout720 of the gradation potential generation circuit 14 cooperate to operate. In addition, as for the switches SW1 to SW16 and the output switches SWout1 to SWout720 of the gradation potential generation circuit 14, on and off are controlled respectively by the control signal 1 and the control signal 2. The details of operation of these switching devices are similar to the first embodiment. Moreover, in this embodiment, although the 10-bit of the data driver IC 3 is explained as an example, it can be applied to the data driver IC 3 of various numbers of bits, as described in the first embodiment. Here, since it is 10 bits, the example of i=8, j=1024 and k=16 is shown.

The same advantageous effect as the first embodiment mentioned above can be obtained in this embodiment. Furthermore, in this embodiment, V0 to V8 are not separately generated within each data driver IC 3, but common V0 to V8 are supplied to each data driver IC 3. Note that these common V0 to V8 are generated by the reference potential generation IC 40 as mentioned above. Thus, since common V0 to V8 are supplied, there is no influence by the variation in the devices between each data driver IC 3. That is, the voltage V0 to V8 between each data driver IC 3 does not vary. Accordingly, the variation in the gradation potentials VDATA0 to VDATA1023 between each data driver IC 3 is suppressed and degradation of image quality is reduced.

In addition, in the present invention, in the structure of the liquid crystal display device shown in FIGS. 1 and 7, an example of connecting the gate driver ICs 2 and the data driver ICs 3 or the like to the liquid crystal panel 4 with IC configuration, they may be structured in an integrated manner with the liquid crystal panel 4.

It is apparent that the present invention is not limited to the above embodiment, but may be modified and changed without departing from the scope and spirit of the invention.

What is claimed is:

1. A gradation potential generation circuit comprising:
a first ladder resistance circuit supplied with a first and a second reference voltages to both ends to generate j number of gradation potentials (j is an integer of 2 or more) and output the generated j number of gradation potentials to j number of first nodes, the j number of gradation potentials being generated by dividing the first and the second reference voltages;
a second ladder resistance circuit to generate k number of gradation potentials out of the j number of gradation potentials (where j>k) generated by the first ladder resistance circuit; and
k number of switches to supply the k number of gradation potentials generated by the second ladder resistance circuit to k number of first nodes out of the j number of first nodes according to a first control signal.

2. The gradation potential generation circuit according to claim 1, wherein the j number of gradation potentials include at least one of the first and the second reference voltages.

3. The gradation potential generation circuit according to claim 1, wherein the second ladder resistance circuit has a resistance value lower than the first ladder resistance circuit.

4. The gradation potential generation circuit according to claim 2, wherein the second ladder resistance circuit has a resistance value lower than the first ladder resistance circuit.

5. The gradation potential generation circuit according to claim 1, wherein the k number of gradation potentials generated by the second ladder resistance circuit have a large potential difference between adjacent gradation potentials near the first and the second reference voltages and a small potential difference between adjacent gradation potentials near the intermediate voltage of the first and the second reference voltages.

6. The gradation potential generation circuit according to claim 2, wherein the k number of gradation potentials generated by the second ladder resistance circuit have a large potential difference between adjacent gradation potentials near the first and the second reference voltages and a small potential difference between adjacent gradation potentials near the intermediate voltage of the first and the second reference voltages.

7. The gradation potential generation circuit according to claim 3, wherein the k number of gradation potentials generated by the second ladder resistance circuit have a large potential difference between adjacent gradation potentials near the first and the second reference voltages and a small potential difference between adjacent gradation potentials near the intermediate voltage of the first and the second reference voltages.

8. A data driver of a display device comprising:
the gradation potential generation circuit according to claim 1;
a decoding circuit input with j number of gradation potentials generated by the gradation potential generation circuit and digital gradation data corresponding to an image data signal to select a gradation potential corresponding to the digital gradation data;
an amplifier circuit to amplify and output a gradation potential output from the decoding circuit; and
an output switch connected between an output end of the amplifier circuit and a data line to supply an output signal of the amplifier circuit to the data line according to a second control signal.

9. A data driver of a display device according to claim 8, wherein the j number of gradation potentials include at least one of the first and the second reference voltages.

10. A data driver of a display device according to claim 8, wherein the second ladder resistance circuit has a resistance value lower than the first ladder resistance circuit.

11. A data driver of a display device according to claim 8, wherein the k number of gradation potentials generated by the second ladder resistance circuit have a large potential difference between adjacent gradation potentials near the first and the second reference voltages and a small potential difference between adjacent gradation potentials near the intermediate voltage of the first and the second reference voltages.

12. The data driver of the display device according to claim 8, wherein the output switch is turned off in a first period within one selection period when a gradation potential is selected by the decoding circuit and turned on in a second period within the one selection period, and
the k number of switches between the first and the second ladder resistance circuits of the gradation potential generation circuit are turned on in a predetermined period within the first period and turned off in the second period.

13. The data driver of the display device according to claim 9, wherein the output switch is turned off in a first period within one selection period when a gradation potential is selected by the decoding circuit and turned on in a second period within the one selection period, and
the k number of switches between the first and the second ladder resistance circuits of the gradation potential generation circuit are turned on in a predetermined period within the first period and turned off in the second period.

14. The data driver of the display device according to claim 10, wherein the output switch is turned off in a first period within one selection period when a gradation potential is selected by the decoding circuit and turned on in a second period within the one selection period, and
the k number of switches between the first and the second ladder resistance circuits of the gradation potential generation circuit are turned on in a predetermined period within the first period and turned off in the second period.

15. The data driver of the display device according to claim 11, wherein the output switch is turned off in a first period within one selection period when a gradation potential is selected by the decoding circuit and turned on in a second period within the one selection period, and
the k number of switches between the first and the second ladder resistance circuits of the gradation potential generation circuit are turned on in a predetermined period within the first period and turned off in the second period.

16. A display device comprising the data driver according to claim 8.
